(19) United States
(12) Patent Application Publication
(10) Pub. No.: US 2012/0219744 A1
(43) Pub. Date: Aug. 30, 2012

(54) THERMALLY RESPONSIVE COMPOSITE MATERIALS

(75) Inventors: Glenn Walker, Cary, NC (US); Ravish Sachar, Raleigh, NC (US); Hua Dong, Raleigh, NC (US)

(73) Assignee: North Carolina State University

(21) Appl. No.: 13/360,186

(22) Filed: Jan. 27, 2012

Related U.S. Application Data
(63) Continuation of application No. PCT/US2010/043348, filed on Jul. 27, 2010.
(60) Provisional application No. 61/228,712, filed on Jul. 27, 2009.

(51) Int. Cl. B32B 1/08; B29C 35/00; B32B 7/02

(52) U.S. Cl. 428/36.91; 428/212; 428/213; 428/216; 264/320

(57) ABSTRACT

A thermally responsive composite material is provided, comprising a first layer, a second layer and a third layer where the third layer is between the first and second layers. The third layer comprises a material having a low glass transition or melting temperature while the first and second layers comprise material having higher glass transition or melting temperatures than the third material. The thermally responsive composite material also comprises a heating element in contact with the third layer. Methods for using the thermally responsive composite material are also provided.

### CROSS-REFERENCE TO RELATED APPLICATIONS

This application is a continuation of international application number PCT/US2010/043348, filed Jul. 27, 2010, which claims priority to U.S. Provisional Patent Application No. 61/228,712, filed Jul. 27, 2009, both of which are incorporated herein by reference in their entirety and for all purposes.

### BACKGROUND OF THE INVENTION

1. Field of the Invention

The present invention relates to thermally responsive composite materials and more particularly to thermally responsive composite materials having a low glass transition temperature material between a lower and upper layer materials having higher glass transition temperatures.

2. Description of Prior Art

Adjustable stiffness materials require a source of energy to modulate their strength. Magnetorheological (MR) and electrorheological (ER) fluids require magnetic and electric fields, which give the user electronic control over fluid shear modulus. The drawback is that even the stiffest actuated MR fluid does not possess much mechanical strength. In addition, the equipment used to induce stiffening is bulky (large electrostatic setup or electromagnet). Thermoplastics show a broader change in strength as their temperature changes, but to date they have been actuated by external sources of heat. An ideal material would thus possess two characteristics: a broad range of adjustable strength that is electronically controllable and a miniaturized source of energy integrated within the smart material.

Only a handful of field-responsive composite adjustable stiffness materials have been demonstrated. MR fluids remain the most common They contain micron-sized particles that line up in parallel with the field lines of an external magnetic field. The organized particles give the bulk fluid an increased apparent viscosity. In compression mode, this shear thickened fluid acts like an adjustable stiffness solid. MR fluids can shear thicken from 2 kPa to a theoretical maximum of 600 kPa, or the equivalent of going from water to compacted wet sand. Shear thickening of plastics at room temperature have moduli of at least a few hundred MPa, or about 3-4 orders of magnitude greater than a strongly actuated MR fluid. ER fluids based on the giant electrorheological effect have demonstrated increases in thickening up to 130 kPa with 5 kV/mm. However, the settling of particles within ER fluid and their susceptibility to humidity are a constant problem. The main disadvantages of field-responsive fluids are that they require large field strengths, revert to fluids when unpowered, and cannot easily be fashioned into arbitrary shapes.

As can be seen, there is a need for a thermally responsive composite material that would be easily shaped or molded using convenient energy sources and would have sufficient structural integrity to be used in a number of applications.

### SUMMARY OF THE INVENTION

In one aspect of the present invention there is provided a thermally responsive composite material comprising a first layer comprising a first material, a second layer comprising a second material, a third layer comprising a third material wherein the third layer is between the first and second layers and at least one heating element in thermal contact with the third layer. The glass transition temperature or melting temperature of the third material is less than the glass transition temperature or melting temperature of the first and second materials.

In another aspect of the present invention there is provided a method for molding the thermally responsive composite material above comprising the steps of, increasing the temperature of the heating element to a temperature greater than the glass transition temperature of the third material but less than the glass transition temperature of the first and second materials, molding the thermally responsive composite material into a desired shape and decreasing the temperature of the heating element to a temperature less than the glass transition temperature of the third material. These steps may be repeated as needed, either to refine the desired shape or to remold the thermally responsive composite material into a new shape.

These and other features, aspects and advantages of the present invention will become better understood with reference to the following drawings, description and claims.

### BRIEF DESCRIPTION OF THE DRAWINGS

FIG. 1A is an illustration showing the thermally responsive composite material of the present invention when no heat is applied;

FIG. 1B is an illustration showing the thermally responsive composite material when heat is applied;

FIG. 2A is a schematic of a thermally responsive composite material having three heating elements in series according to one embodiment of the present invention;

FIG. 2B is an illustration of the thermally responsive composite material of FIG. 2A when heated and with no force applied:

FIG. 2C is an illustration of the thermally responsive composite material of FIG. 2A when heated and a force applied to both ends;

FIG. 3A is a schematic of a thermally responsive composite material according to another embodiment of the present invention;

FIG. 3B shows the thermally responsive composite material of FIG. 3A being formed into a roll;

FIG. 3C shows the thermally responsive composite material of FIG. 3B being used as a catheter;

FIG. 4 shows the assembly of the parts of the thermally responsive composite material according to a further embodiment of the present invention;

FIG. 5 is a plot showing a representative mechanical characterization of a 1.5 mm-thick PCL-based the thermally responsive composite material using the electroforce system and load cell;

FIG. 6 is a plot showing the effect of applied current (heat) on the deflection force of the thermally responsive composite material, measured at a constant displacement;

FIG. 7 is a plot showing the steady-state Young's modulus of the thermally responsive composite material was characterized over a range of currents;

FIG. 8 is a plot showing the top and bottom surface temperatures of the PCL-based the thermally responsive composite material exposed to a 200 mA current for 60 seconds; and

FIG. 9 is a plot showing that the thermally responsive composite material exhibits hysteresis and the force required to deflect a cantilever of adjustable stiffness material a distance of 2 mm depends on whether or not the material is being heated or cooled.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides a thermally responsive composite material comprising a first layer of a first material, a second layer of a second material and a third layer of a third material. The third layer is disposed between the first and second layers. The material also comprises at least one heating element in thermal contact with the third layer. By thermal contact it is contemplated that the heating element will be near enough to the third layer to heat the third material but, although it may be, it need not be in direct physical contact with the third layer. The third material has a glass transition temperature (Tg) or melting temperature (mp), used interchangeably herein, of less than the glass transition temperature or melting temperature of the first and second materials. When the third material is heated to above its Tg, the thermally responsive composite material becomes pliable and can be molded into a desired shape. When the heat is removed from the third layer the third material will return to its original stiffness and the thermally responsive composite material will keep the new shape. Moreover the process is reversible. If heat is subsequently applied to the third layer in the new shape, it may then be reconfigured back to the original shape or into yet another shape.

The thermally responsive composite material of the present invention may be used in medical applications such as, but not limited to, adjustable stiffness catheters for stent applications or other cardiovascular applications in general; adjustable stiffness catheter for long-term catheterization to prevent kinking of the catheter; adjustable/reusable splint or cast; adjustable stiffness surgical tools that change their properties either depending on the tissue type and/or space constraints. Non-limiting examples of non-medical uses for the thermally responsive composite material of the present invention may include adjustable wing tips or other aerodynamic structures in the aerospace industry, tactile feedback operations such as robotic surgery where the operating surface of the tool changes stiffness to simulate the remote environment, on-the-fly adjustable face shields or protective shields or reconfigurable tables, chairs or other structures. It will be appreciated that these are only examples and not limitations on how the thermally responsive composite material may be used. It may be used in any application where it is desirable to have a material that is easily molded or reconfigured without additional equipment or in situ.

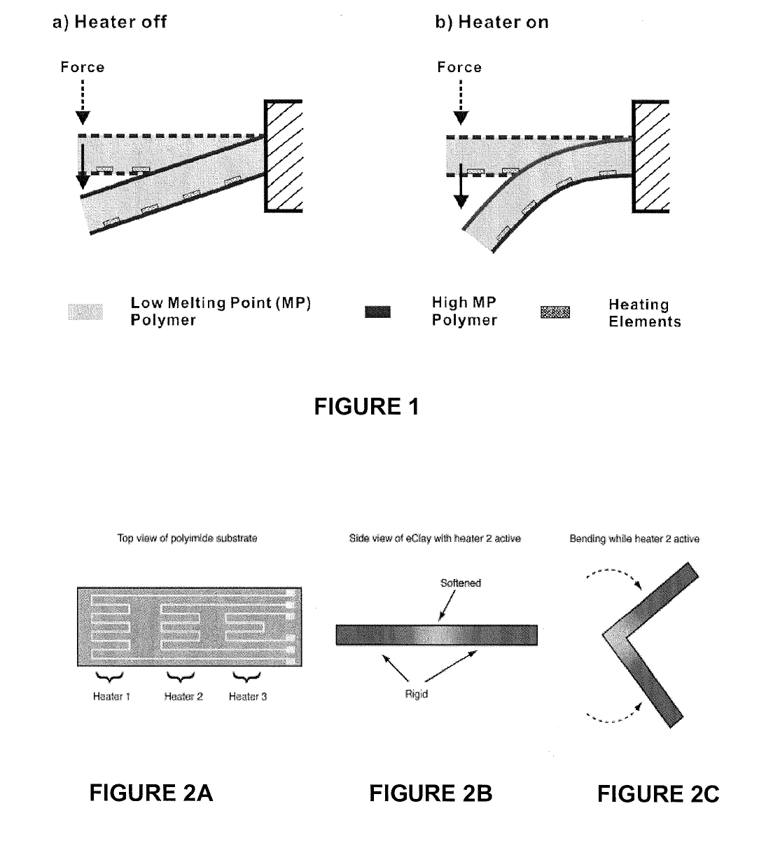

In one embodiment of the present invention there is provided a thermally responsive composite material comprising a first layer comprising a first material, a second layer comprising a second material and a third layer comprising a third material where the third layer is disposed between the first and second layers. The third layer may be in contact with the first and second layers such that a composite material is formed. The glass transition temperature (Tg) or melting point (mp) of the third material may be less than the glass transition temperature or melting temperature of the first and second materials. The thermally responsive composite material also comprises at least one heating element in thermal contact with the third layer. When the third layer is heated by the heating element to a temperature above the Tg of the third material, it becomes pliable, allowing the thermally responsive composite material to be molded and/or shaped as desired (FIGS. 1A and 1B). The third material may be “softened” or “melted” and it should be noted that the terms will be used interchangeably herein as will the terms “glass transition temperature” and “melting point.” The first and second materials of the first and second layers each independently have a Tg greater than the third material such that when the third layer becomes pliable the first and second layers do not soften or melt, providing the thermally responsive composite material with structural integrity that may not be provided by the softened or melted third layer alone.

The first material and the second material may be the same or they may comprise different materials respectively. The first and second materials of the first and second layers should have a Tg higher than that of the third material such that the first and second layers do not soften or melt when heat is applied to the third layer. The first and second layers provide structural integrity to the thermally responsive composite material when heat is applied to the third layer. In an exemplary embodiment of the present invention, the first and/or second materials may independently have a Tg of greater than about 300° C. By way of non-limiting example the first material and/or second material may be a polyimide, poly(methyl methacrylate), polycarbonate or polystyrene.

In another embodiment, the thermally responsive composite material comprises a third layer, the third layer comprising a third material where the third layer is between the first and second layers. The third material may have a Tg that is lower than the Tg of the first and second materials. The difference in Tg values between the third material and the first and second materials should be such that when heat is applied to raise the temperature of the third material above its Tg so that it becomes pliable, the first and second materials remain unaffected and in their original state. By pliable, it is contemplated that upon heating, the third material will become softened or even become a viscous liquid or semi-solid. The difference between the Tg of third material and the first and/or second materials may be greater than about 20° C., 30° C., 50° C., 80° C., 100° C., 150° C. or 200° C. The Tg values are known for a number of materials, particularly polymers, and as such, the skilled artisan would be able to determine which materials to use for the third, first and second layers without undue experimentation. The third material may be chosen based on the desired use of the thermally responsive composite material. For example, for medical applications, it may be desirable to have a Tg less than about 80° C. or alternatively, less than about 50° C. For other applications, such as in aerospace, the third material may have a Tg of about 100° C. to about 200° C. In another exemplary embodiment, the third material may be polycaprolactone, polyamide, poly(butylenes terephthalate)poly(benzyl methacrylate), poly(ethylene isophthalate), poly(ethyl methacrylate), polyethylene terephthalate, poly(isobutyl methacrylate), poly(propyl methacrylate), poly(vinyl acetate) or wax, such as, but not limited to, jewelers wax. If wax is used, it should have a high enough melting point that it retains structural integrity and is not too soft at the base temperature for the desired use.

In yet another embodiment, the third layer may be thicker than the first and/or second layers, respectfully. The thinner outer dimensions of the first and/or second layers ensure that the net material properties of the thermally responsive composite material will be mostly those of the third material of the third layer. The thickness of the third layer may determine how the thermally responsive composite material will behave because the thinner outer layers add little to the overall strength of the material. In an exemplary embodiment, the third layer may have a thickness of from about 25 microns to about 200 microns, or from about 50 microns to about 100 microns. In another exemplary embodiment, the first and/or second layers independently will have a thickness from about 4 times to about 10 times thinner than the thickness of the third layer.

In yet another embodiment, the thermally responsive composite material of the present invention also comprises at least one heating element in thermal contact with the third layer such that the heating element may increase the temperature of all or a part of the third layer. The heating element may be in direct contact with the third layer or close enough that it may easily heat the third layer. In one exemplary embodiment, the heating element is between the first and third layer or between the second and third layer or, alternatively, it may be directly embedded into the third layer. The heating element may be imbedded into the first and/or second layer. Alternatively, the thermally responsive composite material may comprise two heating elements, one being between the first and third layers and the second being between the second and third layers. In yet another embodiment, the thermally responsive composite material may comprise two or more heating elements wherein the heating elements are arranged serially along an axis of the thermally responsive composite material. This may allow greater control of the shaping process wherein only sections of the material may be heated and shaped. This embodiment is illustrated in FIGS. 2A-2C. As shown in FIG. 2A, three heating elements are arranged serially in the thermally responsive composite material. As the center heating element is turned on, the center section softens (FIG. 2B). This allows the thermally responsive composite material to be bent in the center while leaving the ends unperturbed (FIG. 2C).

The heating element may be a resistive heating element where the application of a current will cause the heating element to heat. The current may be provided by any source, including a power outlet, a generator or at least one battery. By using a source such as a generator or a battery, the thermally responsive composite material of the present invention may be used anywhere. The heating element may be microfabricated into either the first, second or third layers using known micro-electrical-mechanical systems (MEMS) or, alternatively it may just lie between the third layer and/or the first and second layer. It may comprise any material that material is electrically conductive and possesses non-negligible resistance. This may include, but not be limited to, metals, conducting polymers or semiconductor materials.

The heating element may be flexible so that the thermally responsive composite material may be rolled into a tube or otherwise formed depending on the desired use.

In an alternate embodiment, the thermally responsive composite material may comprise more than three layers. In an exemplary embodiment, the thermally responsive composite material may comprise a plurality of third layers, each in contact with a heating element. It is contemplated that this arrangement may be more responsive to the application of heat, becoming pliable in a shorter amount of time than a single, thicker third layer. In an exemplary embodiment, the thermally responsive composite material may comprise from about 2 to about 10 layers of the third material, each in contact with a heating element.

In a further embodiment, the thermally responsive composite material may comprise a gasket between the third layer and the first layer to allow space for the thermally responsive third material and to prevent it from seeping from the composite material when heated above its Tg (FIG. 4). The gasket may be an adhesive gasket, sealing the third layer to the first layer.

The thermally responsive composite material of the present invention may be in any desired form. It may be fabricated as a sheet, a tube, or any desired shape. In one embodiment, the thermally responsive composite material is a sheet which is subsequently rolled into a tube. It will be appreciated that the thermally responsive composite material may be in any shape and size depending on the intended use. The thickness of the layers will also depend on the use. The thickness of the layers and the arrangement of the heating element may be determined by the skilled artisan for the desired application without undue experimentation.

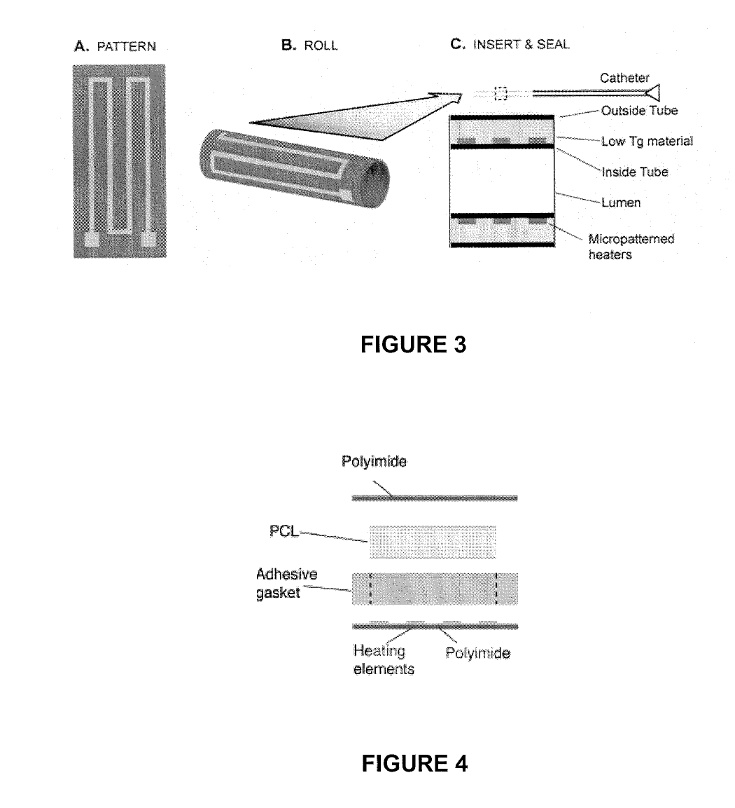

In yet another embodiment, the thermally responsive composite material of the present invention may be formed into a catheter as illustrated in FIGS. 3A-3C. The thermally responsive composite material may be a sheet which is then rolled into a cylinder (FIGS. 3A and 3B) or it may originally be fabricated as a tube, cylinder or a long flat strip can be wound as a helix, similar to a telephone cord. The cylinder may then be slid into a traditional catheter (FIG. 3C) or alternatively, the thermally responsive composite material could serve as the catheter body, without being slid into an existing catheter. The catheter (FIG. 3C) may comprise the cylinder of the thermally responsive composite material for the last 6 inches to 10 inches of the catheter length. The thermally responsive composite material may comprise a portion of the catheter proximal to the end. The annulus between the two is filled with a thin layer of the third material (i.e. third layer) and sealed at both ends of the annulus. The outside surface of the inner catheter (i.e. first or second layer) is covered with a micropatterned heater. The catheter may be inserted into the patient and, when needed, the heater is turned on so that the third material is softened or melted and the catheter may bend as needed.

An adjustable stiffness catheter made from the thermally responsive composite material of the present invention addresses a crucial clinical need for a catheter that is compliant enough to navigate tortuous blood vessels yet stiff enough to remain fixed during stent delivery. There are several problems with the current surgical procedure. First, a stiff catheter must be used to deliver the stent to the lesion site. Compliant catheters slide back, or prolapse, as stents are pushed through them. Second, stiff catheters cannot be guided through the tortuous routes of some of the vasculature, such as the intracranial vasculature, thus limiting a surgeon's ability to deliver a stent to known diseased vessels. In current intracranial procedures, surgeons use compliant catheters to access a lesion and then forcefully hold the catheter in the patient to prevent prolapse as the stent is advanced—a very uncomfortable experience for the patient. In the case of intracranial stent delivery, even the most pliable catheters do not allow surgeons to directly access a lesion, and the subsequent stent transport through the intracranial vasculature to the treatment site can be potentially dangerous to the patient.

Another drawback is that the current stent delivery procedure is very time-consuming, which translates into increased costs and hazards for the patient. At least one series of catheter-to-guide wire exchanges is normally required for proper positioning and up to three can be required. Positioning the catheter near the lesion site can take up to 20% of the total procedure time. In a worst-case scenario, placing the appropriate catheter for intracranial stent delivery can take one hour or more. Each removal and insertion of a guide wire and catheter increases the chances of patient morbidity. As a general rule of thumb, the length of the procedure is proportional to the number and severity of complications. In contrast, a catheter comprising the thermally responsive composite material of the present invention would not require and catheter to guide wire exchanges.

The present invention also provides methods for molding or shaping the thermally responsive composite material of the present invention. It should be noted that the terms “molding” and “shaping” are used here interchangeably. The methods comprise the steps of increasing the temperature of the heating element to a temperature greater than the glass transition temperature of the third material. The amount of heat provided may be controlled such that the third layer is heated above its Tg, but but less than the Tgs of the first and second layers. If the heating element is a resistive heating element, this would comprise providing a current to the heating element using a power source such as an outlet, batteries or a generator. Next, the thermally responsive composite material may be molded into the desired shape such as, but not limited to, molding the material or shaping it into a part or article such as a cup, hook, etc. Finally, the heating element is turned off or the current decreased and the temperature decreased to a temperature less than the Tg of the third material. The third material will then regain its stiffness and the thermally responsive composite material may retain the new shape. The method is reversible and the thermally responsive composite material may be returned to its original shape by repeating the above steps and molding the thermally responsive composite material back to its original form. Alternatively, the steps above may be repeated and the thermally responsive composite materially reshaped as needed.

### EXAMPLE

A microfabricated heater embedded within a composite film was used to modulate the temperature of a low melting point polymer. Currents ranging from 0-200 mA were applied to the microheater and modulated material stiffness ˜100-fold between 1.03 GPa and 10.9 MPa. The outside temperature of the composite ranged from 23-45.5° C. over this range of currents. The softened composite was bent into arbitrary shapes and allowed to re-stiffen, highlighting the reconfigurable nature of the material.

### Experimental

Device Design: The adjustable stiffness film was made by sandwiching a low melting point temperature material between two higher melting point temperature polymers and modulating the temperature of the middle layer. FIG. 1 shows an overview. Cantilevers 27.4 mm long, 18.9 mm wide, and ˜1.5 mm thick were made from the following materials: polyimide tape (Sigma-Aldrich, thickness: 50 μm)) as the top layer, a low melting point temperature material as the middle layer, and a copper-clad polyimide laminate (Pyralux AP7156E, DuPont) as the bottom layer. Polyimide, a popular material for microfabrication, was chosen for the top and bottom substrate due to its good flexibility and excellent physical and chemical stability. Since adjustable stiffness devices for biomedical applications is one use of the present invention, only biocompatible materials with low glass transition temperatures (Tg) or melting points (MP) were investigated for the middle layer: Blue Hard Kerr Inlay Wax (Otto Frei, Inc.), MP: 61° C., nylon 66 (Advanced Industrial, Inc), Tg: 50° C., polyurethane (Sigma-Aldrich), MP: 50° C., polycaprolactone (Sigma-Aldrich), MP: 57° C., and poly(vinyl acetate) (Sigma-Aldrich), Tg: 35° C. All middle layer films except nylon 66 were prepared via hot-pressing. Nylon 66 was used as received. The cantilever was assembled by putting the polymer films onto the microheater (bottom layer) followed by gently attaching polyimide tape to seal the whole device.

Fabrication of Microheater: The bottom polyimide layer containing the integrated heater was fabricated via traditional microfabrication techniques. Double-sided copper-clad polyimide laminate, containing a 9 μm thick copper layer on either side of a 50 μm thick polyimide film, was first patterned using photolithography, then etched with copper etchant (CE-100, Transene, Inc.) and finally washed with acetone to remove the photoresist (AZ1518). The resulting resistive heater comprised a meandering pattern with a line width of 100 μm and inter-line width of 100 μm. The final heater resistance was measured to be 60Ω.

Mechanical Force Measurement: Mechanical force measurements of the cantilevers were performed using a Bose ElectroForce Test Instrument (Bose Corporation, Eden Prairie, Minn.). Two load cells (250 g and 1000 g) were used for different force ranges (0-2.5N and 2.5-10N, respectively). Cantilevers were fixed on a stationary platform for testing. A custom-made probe tip was attached to the load cells and used for deflection testing. The cantilevers were characterized by performing two types of measurements: force as a function of displacement over 6 mm, and the change in force of a static cantilever (i.e., no displacement) as current was applied to soften the middle layer.

Differential Scanning Calorimetry (DSC): Polycaprolactone (PCL) was found to be an optimal material due to its combination of a low melting point and large change in Young's modulus over temperature. In order to quantify the crystallization and melting temperatures of PCL, DSC was carried out with a thermal analyzer (DSCQ100 TA instrument, New Castle, Del.) under a nitrogen atmosphere. Each sample (˜10 mg) was heated from −80 to 100° C. at a heating rate of 10° C./min. The crystallization and melting temperatures were taken as the top and bottom peaks, respectively.

### Results and Discussion

Mechanical characterization: The adjustable stiffness cantilever, with PCL as the middle layer, was used to determine the effect of applied current (i.e., internal temperature) on mechanical stiffness. Stiffness was determined by measuring the amount of force required to deflect the cantilever tip 6 mm and then calculating the Young's modulus. The Young's modulus, E, of a cantilever of length L fixed at one end and subject to a point load, F, at a distance, x (19 6 mm), from the fixed end is given by the equation

$$E = \frac{2 F}{{ywt}^{3}} ( 3 {x}^{2} L - {x}^{3} ) \qquad ( 1 )$$

where y is the vertical displacement of the cantilever, w is the cantilever width (18.9 mm), and t is the cantilever thickness (1.5 mm) (Kovacs, G.T.A., Micromachined Tranduces Sourcebook, WCB/McGraw-Hill, Boston (1998)).

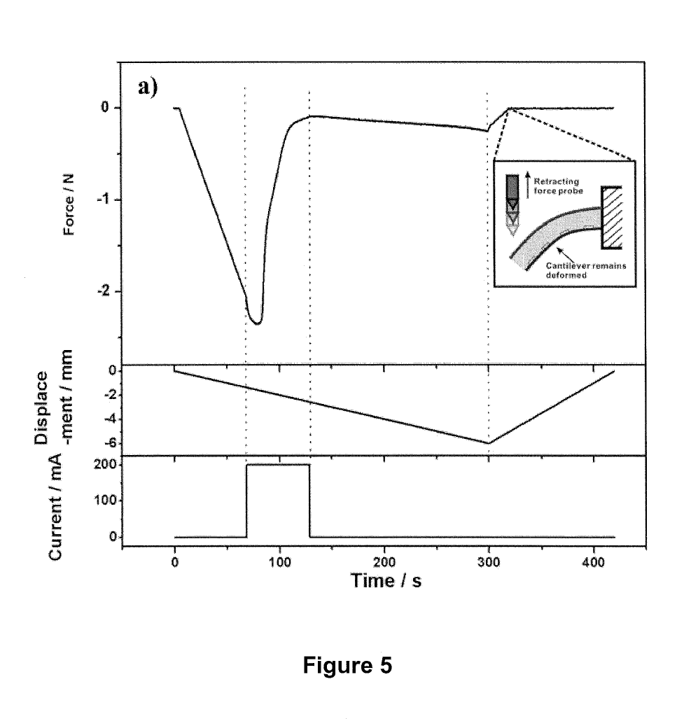

FIG. 5 shows the effect of current on the mechanical stiffness of the cantilever. The top part of FIG. 5 shows the force measured during the testing procedure; the middle, the displacement of the sensing probe; and the bottom, the amount of current applied to the microheater over time. The cantilever was fixed at one end and the other end was pushed down by the load cell at a rate of 0.02 mm/s and withdrawn at a rate of 0.04 mm/s During the movement of the film, a 200 mA current was applied to the microfabricated resistive heater for 60 s. Initially (no heating) the force increased linearly with displacement, indicating that the cantilever can be modeled using Equation 1. When current was turned on at t=68 sec, the force first increased quickly and then decreased until the current was terminated at t=128 sec. The increase in force during the initial heating period can be ascribed to the thermal expansion of residual gas in the PCL thin film, making it temporarily stiffer. The cantilever then lost its stiffness and reached a steady-state stiffness value by the end of the 60 sec heating window. Once the current was removed, the dropping temperature of the cantilever caused the deflection force to resume increasing as the PCL layer solidified. During probe tip retraction, the measured force on the cantilever quickly went to 0 N, indicating that the cantilever was retaining its deformed shape even when no external perturbing force was present—a key advantage of the adjustable stiffness film as shown in FIG. 5 (inset).

At the largest displacement (6 mm) of the cantilever, the measured force with no current was 9.44 N, corresponding to a Young's modulus of 1.03 GPa. In contrast, the measured force after 60 s of heating was 0.10 N, or a Young's modulus of 10.9 MPa. Thus, the stiffness of the cantilever after applying a 200 mA current for 60 sec was approximately 1.1%, or 100-fold less than, the stiffness at room temperature.

In addition to PCL, other polymers were tested as middle layers for the cantilever such as wax, nylon 66, waterborne polyurethane (WPU) and poly(vinyl acetate) (PVAc). The ratio of the film stiffness with and without applying a 200 mA current for 60 sec was calculated as 2.3% for wax, 31.0% for nylon, 47.8% for WPU and 10.2% for PVAc. These results confirm that PCL is the best material with the largest change in stiffness among the low melting point temperature polymers that we tested.

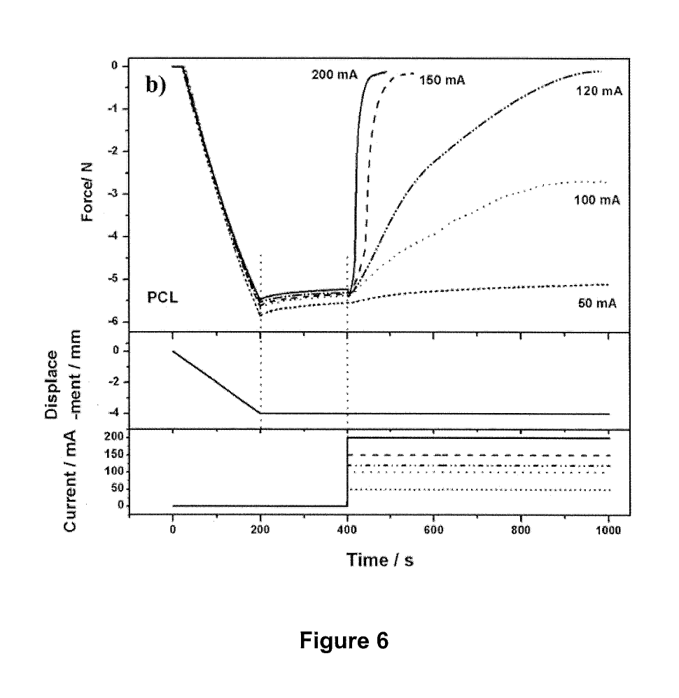

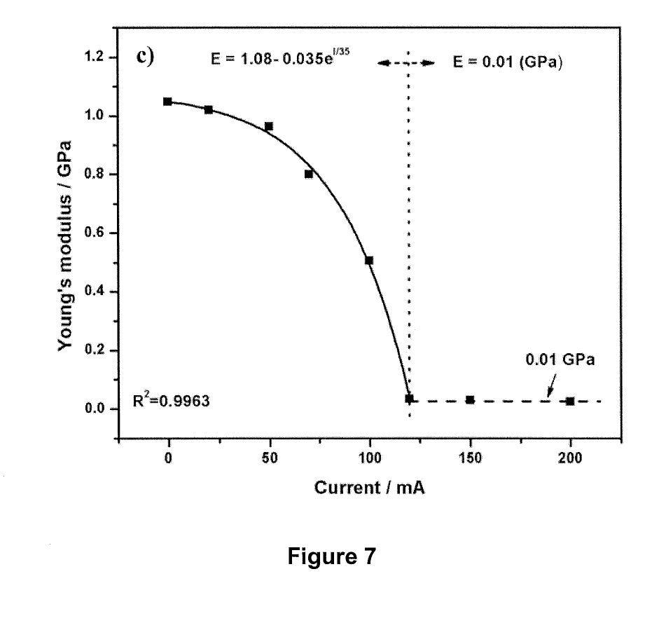

The steady-state deflection force depended on the current amplitude, as shown in FIG. 6. The experimental protocol was divided into two steps: the cantilever was first deflected from 0 mm to 4 mm at a rate of 0.02 mm/s, followed by quiescence at 4 mm for 800 sec. The deflection force was found to increase with the bending of the cantilever until its displacement was 4 mm An extra 200 sec was allowed for the cantilever to reach equilibrium at room temperature before applying a current. A series of currents were then applied to the cantilever and the change in force versus time was recorded for each. The top part of the plot in FIG. 6 shows the change in steady state deflection force; the middle part, the transient and then constant displacement of the sensing probe; and the bottom, the current applied to the microheater. For currents greater than 120 mA, the final steady-state deflection force was always ˜0.1N, regardless of initial deflection distance. The force required to deflect the cantilever was always independent of the current used for heating, as long as the generated heat could fully melt the middle layer. As current amplitude increased, the time to achieve the steady-state deflection force of ˜0.1 N decreased. At currents below 120 mA the steady-state deflection force, and thus Young's modulus, was a function of the current amplitude, as shown in FIG. 7. The final deflection forces for the currents of 50 mA, 100 mA, and 120 mA were 5.1 N, 2.7 N and 0.1 N, respectively. These data indicate that the stiffness of the cantilever could be adjusted to any values within the range of 10.9 MPa-1.03 GPa using currents ranging from 0-120 mA. Fitting a curve to the data points in FIG. 2c yields the equation

E=1.08−0.035e^{I/35} (0≦I≦120 mA) (2)

where I is the applied current and E is the steady-state Young's modulus (in GPa) of the cantilever. Currents larger than 120 mA can shorten the time needed to change the stiffness but always yield a final Young's modulus of 10.9 MPa. Thus, there is a tradeoff between the rate of stiffness change and control over the degree of steady-state stiffness.

The adjustable stiffness cantilevers used for this example were about the size of a postage stamp, but different sizes, up to the size of a conference poster or larger, could be made. Small constructs 7 cm long and 7 mm wide were fabricated and used to demonstrate how the material can be molded into arbitrary shapes such as, but not limited to, a square, a circle, a horseshoe, an oval or a heart. Current was applied to the constructs which were then held in particular shapes. Not only has the minimum bending radius of the material been quantified, a flat sample was easily recovered from the shapes fabricated for this example. Turning the current off caused the middle layer to solidify and retain the new shape. The material is easily bent into multiple shapes using one's hands. The construct does not become too hot to handle even after 200 mA of current for 60 sec, as shown by the temperatures in Table 1. The temperature gradient within the film increases as the current increases due to changing PCL properties and the temperature gradient with respect to the environment. Polyimide is a good thermal insulator, which minimizes the amount of heat escaping from the material. In ambient environmental conditions, the construct took about 45-50 sec to totally soften with a current of 200 mA. Once it was fashioned into a new geometry, the construct took about 200 sec to re-stiffen and hold its shape. These rapid response times are a result of the microscale lengths involved. The thin PCL layer in intimate contact with the resistive heaters ensures that the material will rapidly heat up, while the large surface area to volume ratio of the material allows rapid cooling. Even though the middle layer is changed to a highly viscous fluid upon melting, the thickness of the construct stayed approximately uniform (i.e., reflow of the PCL within the construct was minimal).

TABLE 2
The top and bottom film temperatures were measured after
heating for 60 sec at several current levels.

| | Top temperature/ | Bottom | Temperature |
|---|---|---|---|
| | ° C. | temperature/° C. | difference/° C. |
| 50 mA | 22.98 | 23.89 | 0.91 |
| 100 mA | 26.30 | 30.95 | 4.65 |
| 150 mA | 31.62 | 39.00 | 7.38 |
| 200 mA | 36.38 | 45.51 | 9.13 |

Thermal characterization: The outside temperature of the cantilever is determined by the amount of Joule heating within the micropatterned resistive heater. As the current increases, Joule heating raises the cantilever temperature. At the same time, the rate of heat flow out of the cantilever also increases because of the increased temperature gradient with respect to the environment. Eventually the cantilever reaches a steady-state temperature once heat flow out of the cantilever equals the amount of heat generated by the resistive heater. Evidence of the steady state temperature is shown by the constant deflection forces in FIG. 6.

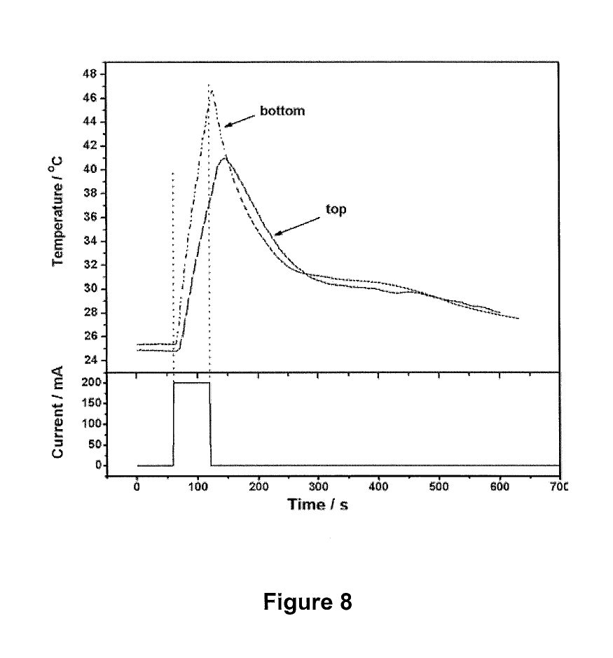

The cantilever temperature was measured by attaching surface-mount thermistors to its top and bottom surfaces. FIG. 8 shows the top and bottom surface temperatures before and after heating at 200 mA for 60 sec. The bottom surface, which contains the microfabricated heater, registered an immediate temperature increase when the current was switched on, while the top surface temperature showed a delay of several seconds before its temperature increased. The temperature delay was a result of the delayed heat flux through the middle (PCL) layer. At 60 sec, the top and bottom surface temperatures were 36.4° C. and 45.5° C. After switching the current off, both temperatures briefly continued to increase before decreasing. The top layer showed a delayed temperature drop compared to the bottom layer. The effects of different current amplitudes on cantilever temperature were also tested and are summarized in Table 1. The temperature difference between the top and bottom surfaces became larger at as currents increased, which suggests that the thermal conductivity of the PCL is a function of temperature and decreases when the temperature of the cantilever rises.

A 3D finite element model of the cantilever was simulated using COMSOL multiphysics software. The temperature change of the cantilever with a 200 mA current was modeled. All the parameters except thermal conductivity of PCL were found in earlier publications (see Table 2). Based on the measurements in Table 1, the average value of the thermal conductivity of the middle PCL layer was assumed to be 0.08 W/(m·K) instead of 0.18 W/(m·K) measured at room temperature. After running the simulation for 60 sec, the top and bottom surface temperatures were 36.18° C. and 45.06° C., respectively, which are in good agreement with the empirical measurements (top:36.38° C., bottom: 45.51° C.).

TABLE 2
Model: Heat transfer by conduction (transient analysis)
Parameters:

| | Thermal | Heat capacity at | |
|---|---|---|---|
| | conductivity | constant pressure | Density |
| | [W/(m · k)] | [J/(kg · k)] | [kg/m³] |
| Polyimide | 0.5 | 1150 | 1430 |
| PCL | 0.085 | 1230 | 1050 |
| Copper | 400 | 385 | 8700 |
| Heat transfer | 5 [W/(m² · k)] | | |
| coefficient (air) | | | |

The mechanical properties of the cantilever at different constant temperatures, especially around 37° C. considering its possible biomedical applications was studied.

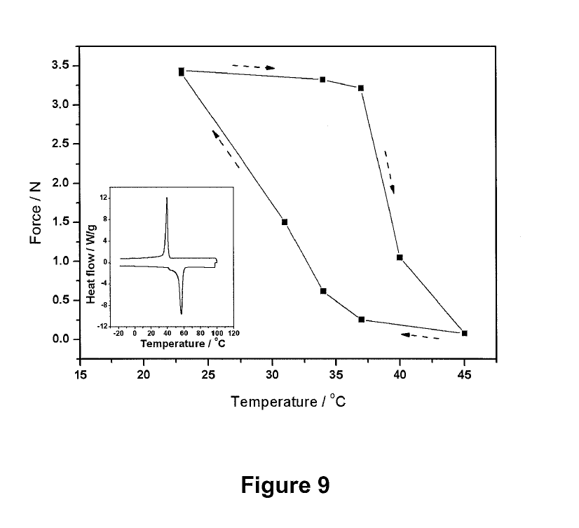

Experiments were conducted in which the temperature of the cantilever was set to a specific value and allowed to equilibrate with the environment for 30 min The cantilever was then displaced 2 mm Manual adjustment of the current source and visual inspection of the measured temperature on the top surface ensured that a constant temperature was maintained during testing. FIG. 9 shows the force measurements on the device in the temperature range of 23-45° C. When the device was heated above room temperature, the deflection force remained constant at 3.3N until the temperature reached ˜37° C. Thereafter, the deflection force rapidly decreased between 37° C. and 40° C., and eventually reached a minimum force of 0.1 N at 45° C. This dramatic change in stiffness over a temperature difference of 3° C. highlights that only a small amount of heat is needed to reduce stiffness if used inside the human body.

As the temperature was decreased from 45° C., the deflection force stayed approximately constant until the temperature was lower than 34° C., resulting in a stiffening hysteresis effect, as shown in FIG. 9. DSC was used to determine the melting and re-crystallization points of pure PCL polymer (FIG. 9, inset): 57° C. and 39° C., respectively. Thus, a lower temperature is needed for nucleation, and subsequent re-stiffening, of PCL compared to melting. Two strategies could be used to minimize the hysteresis. One is to prepare PCL polymers that contain nanoparticles. The addition of nanoparticles as nucleating agents can facilitate the formation of PCL crystals at higher temperature and thus shorten the temperature difference between the melting and re-crystallization process. The other method is to bathe the PCL with a cool liquid or stream of air, thus rapidly reducing its temperature below the re-crystallization point.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A thermally responsive composite material comprising:
a first layer comprising a first material;
a second layer comprising a second material;
a third layer comprising a third material wherein the third layer is between the first and second layers; and
at least one heating element in thermal contact with the third layer;
wherein the glass transition temperature or melting temperature of the third material is less than the glass transition temperature or melting temperature of the first and second materials.

2. The thermally responsive composite material of claim 1 wherein the first material and the second material are the same.

3. The thermally responsive composite material of claim 1 wherein the at least one heating element is embedded in either the first or the second layer.

4. The thermally responsive composite material of claim 1 wherein the at least one heating element is embedded in the third layer.

5. The thermally responsive composite material of claim 1 further comprising a second heating element wherein the first heating element is disposed between the first layer and the third layer and the second heating element is disposed between the second layer and the third layer.

6. The thermally responsive composite material of claim 1 comprising a plurality of heating elements wherein the heating elements are arranged serially in the thermally responsive composite material.

7. The thermally responsive composite material of claim 1 wherein the glass transition temperature of the first and second materials is greater than about 100° C.

8. The thermally responsive composite material of claim 1 wherein the glass transition temperature of the first and second materials is greater than about 300° C.

9. The thermally responsive composite material of claim 1 wherein the third material is polycaprolactone, polyamide, poly(butylenes terephthalate)poly(benzyl methacrylate), poly(ethylene isophthalate), poly(ethyl methacrylate), polyethylene terephthalate, poly(isobutyl methacrylate), poly(propyl methacrylate), poly(vinyl acetate) or jewelers wax.

10. The thermally responsive composite material of claim 1 wherein the first or second material independently are polyimide, poly(methyl methacrylate), polycarbonate or polystyrene.

11. The thermally responsive composite material of claim 1 wherein the first and second materials are polyimide.

12. The thermally responsive composite material of claim 1 wherein the first and second materials are polyimide and the third material is polycaprolactone.

13. The thermally responsive composite material of claim 1 wherein the thermally responsive composite material is in the form of a sheet or a tube.

14. The thermally responsive composite material of claim 1 wherein the heating element is a resistive heating element.

15. The thermally responsive composite material of claim 1 wherein the third layer has a thickness of from about 25 microns to about 200 microns.

16. The thermally responsive composite material of claim 1 wherein the first or second layers independently have a thickness that is from about 4 times to about 10 times thinner than the thickness of the third layer.

17. The thermally responsive composite material of claim 1 wherein the first, second and third layers each independently have a thickness of from about 50 microns to about 100 microns.

18. A method of molding the thermally responsive composite material of claim 1 comprising the steps of:
increasing the temperature of the heating element to a temperature greater than the glass transition temperature of the third material but less than that of the glass transition temperatures of the first and second layers;
molding the thermally responsive composite material into a desired shape; and
decreasing the temperature of the heating element to a temperature less than the glass transition temperature of the third material.

19. The method of claim 18 wherein the heating element is a resistive heating element, wherein the temperature of the heating element is increased by applying a current to the heating element and decreased by stopping the current to the heating element.

20. A catheter comprising:
a thermally responsive composite material including a first layer comprising a first material; a second layer comprising a second material; a third layer comprising a third material wherein the third layer is between the first and second layers; and at least one heating element in thermal contact with the third layer; wherein the glass transition temperature or melting temperature of the third material is less than the glass transition temperature or melting temperature of the first and second materials.
